(19) United States
(12) Patent Application Publication
(10) Pub. No.: US 2026/0310445 A1
(43) Pub. Date: Oct. 8, 2026

(54) UPGRADING AN INFRASTRUCTURE SOFTWARE STACK

(71) Applicant: MELLANOX TECHNOLOGIES, LTD., Yokneam (IL)

(72) Inventors: Parav Kanaiyatal Pandit, Bangalore (IN); Ron Yuval Efraim, Tzor Hadash (IL); Roni Bar Yanai, Even Yehuda (IL); Jason Gunthorpe, Bedford (CA); Gabi Liron, Yokneam Illit (IL); Eyal Davidovitz, Kfar Saba (IL); Natan Oppenheimer, Mitzpe Netofa (IL); Bodong Wang, Austin, TX (US); Saeed Mahameed, San Jose, CA (US); Eitan Hirschberg, Haifa (IL)

(21) Appl. No.: 19/399,117

(22) Filed: Nov. 24, 2025

Related U.S. Application Data
(60) Provisional application No. 63/783,327, filed on Apr. 4, 2025.

(51) Int. Cl. G06F 8/656; G06F 9/455

(52) U.S. Cl. CPC G06F 8/656; G06F 9/45558; G06F 2009/45562; G06F 2009/45595

(57) ABSTRACT

Approaches in accordance with various illustrative embodiments provide for the upgrading of a software stack that controls network traffic for a tenant virtual machine (VM) in a datacenter. A software defined networking (SDN) stack can be deployed as a VM owned by a cloud solution provider (CSP). When an upgrade to the software stack is to be performed, a new VM can be deployed in the CSP environment that is identical to the current control VM but will include the upgraded software stack including the appropriate operating system (OS) kernel. The new VM software stack can then be activated, enabling the upgraded software stack to be available to manage the traffic of the tenant VM with almost no downtime. The new VM can take over the control plane and manage network traffic for the tenant VM.

### CROSS-REFERENCE TO RELATED APPLICATIONS

This application claims priority to U.S. Provisional Patent Application Ser. No. 63/783,327, filed Apr. 4, 2025, and entitled “Upgrading an Infrastructure Software Stack for Accelerated Hardware,” which is hereby incorporated herein in its entirety and for all purposes.

### TECHNICAL FIELD

This disclosure relates generally to the management of computing resources, and in at least one embodiment relates to the updating of software in a virtualization layer used to manage tenant traffic in a shared resource environment.

### BACKGROUND

There are many situations where users will rely upon shared resources of a resource environment, such as may be provided by a cloud solution provider (CSP) using resources of a datacenter, to perform various tasks. A user may be allocated a tenant virtual machine (VM) that is hosted on at least one of these CSP resources, as well as shared network acceleration hardware. A control VM will be allocated in the CSP environment that can allow for managing network traffic associated with the tenant VM, and the control VM will include a software stack that may include CSP applications, device drivers, and middleware, among other such options. When the software stack is to be upgraded stack, the control VM must first be deactivated with respect to managing network traffic. The control VM can then be reactivated once the upgrade has completed. Unfortunately, the control VM being deactivated for a period of time can negatively impact traffic associated with the tenant VM, as there will be no control VM available for a period of time that can manage the network traffic. As such, the network traffic may be subject to issues such as violating quality of service (QoS) settings, missing encryption or encapsulation, packet loss, or unacceptable latency, among others. In some solutions, upgrading of an entire software stack can take hours to complete at the level of a datacenter, cluster, artificial intelligence (AI) factory, which will be an unacceptable amount of time to have tenant traffic disrupted in many instances.

### BRIEF DESCRIPTION OF THE DRAWINGS

Various embodiments in accordance with the present disclosure will be described with reference to the drawings, in which:

FIG. 1 illustrates an example system architecture in which aspects of various embodiments can be implemented, according to at least one embodiment.

FIG. 2 illustrates a view of an example subset of components of the example system of FIG. 1.

FIG. 3A illustrates an example process to upgrade a software stack used to control tenant traffic with respect to shared network acceleration hardware, according to at least one embodiment.

FIG. 3B illustrates another example process to upgrade a software stack, according to at least one embodiment.

FIG. 4 illustrates an example system for hosting virtualization software, according to at least one embodiment.

FIG. 5 illustrates an example datacenter system, according to at least one embodiment.

FIG. 6 is a block diagram illustrating a computer system, according to at least one embodiment.

FIG. 7 illustrates components of a system including multiple processing units connected by network switches, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various illustrative embodiments provide for the upgrading or modification of a software stack that controls network traffic for a tenant virtual machine (VM) in an environment such as a cloud-type shared resource environment (e.g., a datacenter or AI factory). Such upgrading can occur, for example, for a tenant VM which uses east-west networking infrastructure (for network traffic among devices in a datacenter) in an AI platform. A software defined networking (SDN) stack can be deployed as a control VM owned by a cloud solution provider (CSP). Other types of controllers can be used as well within the scope of the various embodiments, as may comprise control plane containers or Kubernetes Pods, among other such options. Approaches in accordance with the present disclosure can deploy a new control standby VM, in the CSP environment, that will include the upgraded software stack including the appropriate operating system (OS) kernel. This new privileged VM (pVM), or control standby VM, can be identical to the current control pVM that actively manages traffic for the tenant VM, but can include the upgraded software stack. This new control standby VM can run the application stack and the networking accelerator hardware in standby mode until the stateful application state setup has completed successfully. The new virtual machine application stack and attached network accelerator hardware can then be activated, enabling the upgraded software stack to be available for use with almost no downtime for the traffic of the tenant VM. The new control standby VM can then take over the control plane and manage network traffic for the tenant VM. This activation control can effectively activate the new hardware and control plane, and its attached hardware accelerators can become the new active stack. Such an approach can be used in various domains, such as a networking domain in which network adapters are capable of switching packets and controlling the tendency of traffic, where the underlying hardware can include a network interface card (NIC) with an embedded switch, a NIC with graphics processing unit (GPU)-like functionality, or a data processing unit (DPU), among other such options.

Variations of this and other such functionality can be used as well within the scope of the various embodiments as would be apparent to one of ordinary skill in the art in light of the teachings and suggestions contained herein.

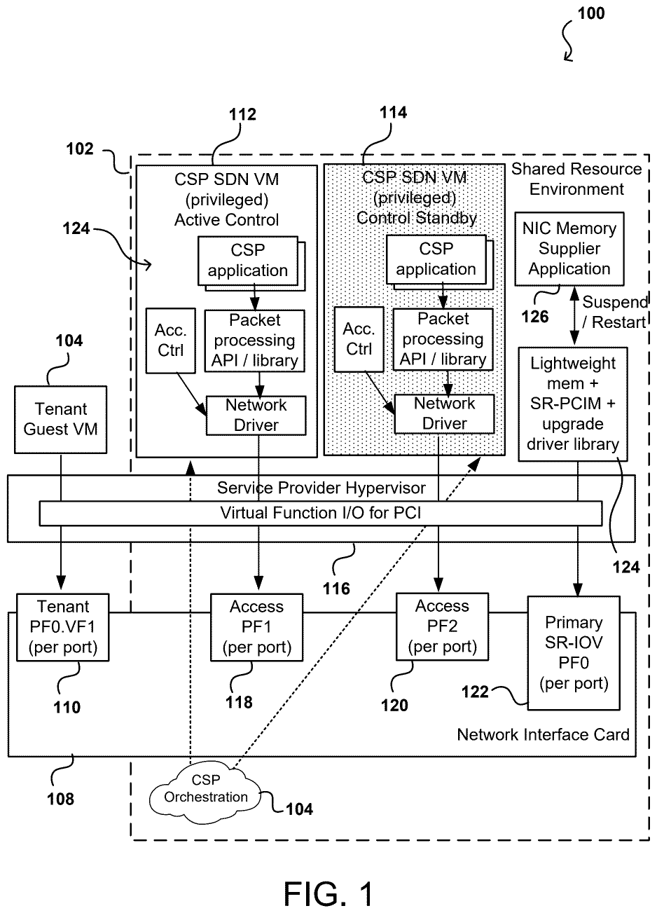

FIG. 1 illustrates components of an example system 100 that can be used to route network traffic according to at least one embodiment. This system includes shared resources that are provided by a resource provider, or “cloud” provider, as part of a complex computing environment, such as a datacenter. The illustrated system uses an east-west networking architecture in an AI platform. As illustrated, there can be a tenant guest virtual machine (VM) 104 that runs on a service provider hypervisor 116 and can send network traffic through an instance of networking hardware, such as a network interface card (NIC) 108. The tenant can have a virtual function (e.g., VF1) corresponding to a physical port (PF0) on the NIC 108. There can also be a virtual machine 112 in the shared resource environment 102 that manages the control plane and data plane to be used to direct network traffic for the tenant guest VM 104 through a first physical access port, access PF1 118. This current VM can be managed by the cloud solution provider (CSP), for example, and may include the software-defined network (SDN) stack needed to manage network traffic for the tenant guest VM. The SDN software stack typically consists of three layers, including an application layer, a control layer, and an infrastructure layer for physical network devices. These layers can communicate via northbound and southbound APIs. The shared resource environment 102 can host various applications, such as an application 126 associated with a supplier of a NIC 116 used for communication. As discussed in more detail elsewhere herein, there may be various resources 124 in the shared resource environment 102 that can assist in the execution of the NIC memory supplier application 126, as may include lightweight memory and a single root PCI manager (SR-PCIM) that can be responsible for tasks such as configuration and management of various virtual functions supported by the system, as well as supporting SR-IOV management.

During operation, it may be determined that the software stack in the CSP SDN control VM 112 is to be updated. Since the CSP SDN control VM 112 actively controls the traffic of the tenant guest VM 104, it can be undesirable to take the CSP SDN control VM 112 offline, or otherwise make it unavailable for a period of time, as that would impact the network traffic for the tenant guest VM 104, potentially resulting in problems such as violating quality of service (QoS) settings, missing encryption or encapsulation, packet loss, or unacceptable latency, among other such undesirable outcomes. As mentioned, the SDN software stack is owned and/or controlled by the CSP, and a service provider hypervisor 116 will typically not run an SDN stack.

Approaches in accordance with at least one embodiment can allow for upgrading of a privileged software stack including an operating system (OS), for example, without affecting the network traffic for a tenant guest VM 104. In one example, a privileged SDN software stack of an appliance is able to be upgraded with little-to-no detectable downtime for the tenant VMs in corresponding AI platforms. In this example, an upgrade to be applied to a software stack can be identified. The CSP SDN control VM 112 can be copied to create a new, similar parallel control standby VM 114 that will initially operate in a standby (or similar) mode. The update can be applied to the software stack of this new, privileged control standby VM 114, so that the control standby VM 114 is effectively a copy of the CSP SDN control VM 112 but with the software stack update applied. This new software stack and the attached network accelerator hardware (which controls the control plane) can run in standby mode until all the necessary setup has completed. After any necessary (or at least appropriate) configuration has completed, software components inside the control standby VM 114 and network accelerator (APF) can be activated to allow the control standby VM 114 to function as the new CSP SDN control VM. In this way, the current CSP SDN control VM 112 can remain processing network traffic for the tenant guest VM 104 using the shared NIC 108, until such time as the newly active control standby VM 114 is able to take over the processing. In at least one embodiment, the newly active control standby VM 114 can declare itself in control and take over management of the active control plane corresponding to the tenant, and can cause the “currently” (here previously) active CSP SDN control VM 112 to go into standby mode, or take another action so the CSP SDN control VM 112 is no longer active, at least for purposes of controlling the networking.

Such architecture might be useful where, for example, there is an artificial intelligence (AI) cluster of graphics processing units (GPUs) and NICs working together in a server, where that server is running a workload for an AI application. While that workload is running, this AI server (as well as potentially other resources in the shared resource environment 102, can be allocated (in whole or in part) to at least one tenant, or “customer” of the CSP. That tenant can then use those resources to perform various tasks, such as to run an AI application and mine their data according to specific criteria. While that software stack is running, the CSP infrastructure is also running a software stack, referred to herein as an SDN stack, that controls this traffic. In FIG. 1, this CSP SDN stack is running (at least initially) on a currently active CSP VM 112. The SDN stack consists of several layers, including at least one SDN application at a top layer that relies on some packet processing libraries and APIs in the middleware layers, with access control also leveraging a bottom, network driver layer, although other layer selections and configurations can be used as well within the scope of various embodiments. The currently active control VM 112, which is owned by the CSP, can be used to control traffic for the tenant guest VM 104, using tenant virtual function PF_0.VF_1 110 on the NIC 108. The tenant virtual function 110 in this example is a networking PCI function. Any receival and/or transmission of packages, such as for RDMA and networking, can be managed according to that tenant virtual function 110. The traffic that can be transmitted and received, as well as the rate at which the traffic can be transmitted and received, can be controlled by the currently active control VM 112 of the CSP.

A currently active SDN control VM 112 can control traffic using an access physical port, here access PF1 118. Access PF1 in this example is a physical networking function, such as a peripheral component interconnect (PCI) function. A primary role of access PF1 118 is to monitor and control the traffic for at least the hosted tenant guest VM 104. In one example, the access PF1 can analyze a packet to determine whether the packet includes certain feeds, and if so, the packet can be denied from being transferred on the relevant network. Access PF1 can perform control, encryption, and encapsulation actions on network traffic. Encryption can be beneficial as the cloud resources may be shared but a tenant wants to ensure that its data is not exposed to other entities. Encapsulation can be beneficial as the datacenter may be wide enough to span across multiple buildings, multiple switches, and/or routers where encapsulation may be needed, or at least beneficial.

As mentioned, at some point it may be determined that the software stack running in the currently active control VM 112 should be upgraded. There can be various reasons to perform such an upgrade, as may be related to bug fixes, performance improvements, or security updates, for example, which may span across several layers. The update could include one or more layers in the software stack 124, such as a CSP application, a packet processing API or library (or Docker flow or other middleware for the traffic), or a lower level Linux driver. Using a conventional approach to upgrading the software stack could be troublesome, as it would not be possible to terminate and upgrade one or more components or layers of the software stack 124 without interrupting the traffic for the tenant guest VM 104.

Approaches in accordance with various embodiments can avoid such interruptions by, in part, attempting to minimize the time that a VM with an appropriate software stack is to be unavailable for traffic processing. In FIG. 1, there is a currently active control VM 112 that is managing traffic and has implemented an appropriate routing solution for a respective tenant guest VM 104. It can be beneficial to leverage this working solution, but simply upgrade the relevant software stack components as appropriate. A new instance of the currently active control VM 112 can be instantiated as a newly added control standby VM 114, with a new virtual machine image, that replicates the solution of the currently active control VM 112. The newly added control standby VM 114 will differ from the currently active control VM in that it will include the upgraded, updated, or new software stack that is to be used going forward. The newly added control standby VM 114 can have the necessary configuration applied, and can be launched to be able to manage network traffic for the tenant guest VM 104. The control standby VM 114 can determine that it is identical to the currently-active control VM (other than the software stack) 112 and can then take over management of the customer control plane (and data plane) from the currently active control VM 112, which will then no longer be actively managing network traffic for the tenant guest VM 104. The newly added control standby VM 114, once active, can then take over the data plane without losing any packets on the network, which are being received and/or transmitted by the tenant function PF0.VF1 110. The upgrades to the software stack in the control standby VM can include any appropriate changes, such as an updated version of a CSP application that patches one or more bugs. By including this updated version in the newly added control standby VM 114 and allowing for a fast switchover of SDN control VMs, there should be no interruption to network traffic for the tenant guest VM 104, as would be required if the upgrade were instead applied to the software stack of the currently active control VM 112, which could then potentially interrupt network traffic during the duration of time it took to perform the software upgrade. In some embodiments, the newly added control standby VM may need to obtain context information for the CSP application before taking over control of the network traffic for the tenant guest VM 104.

In FIG. 1, it is illustrated that a majority of the components are logically considered to be part of the shared resource environment 102 and accessible to a cloud solution provider (CSP)—or other entity in charge of the shared resource environment—and thus subject to modification and control by the CSP. There are components that are illustrated to be outside the shared resource environment 102, including the tenant guest VM 104 and the tenant virtual function 110. It should be understood that in many instances, the tenant guest VM 104 and the tenant virtual function 110 will be hosted using physical resources of the shared resource environment 102, but will logically be owned by a tenant, or customer of the CSP. In many instances, the CSP will not be authorized to modify the tenant guest VM 104 or tenant virtual function 110, or may be authorized but should avoid such modification unless authorized and/or necessary. For a software stack upgrade (or similar action) as discussed herein, it can be desirable in at least many situations to allow the tenant guest VM 104 and tenant virtual function 110 to continue to operate without interruption, or in many instances without knowledge that the software upgrade or VM switchover has occurred. Neither component may be aware of the currently active control VM 112, or “control” VM, that controls the hardware that the tenant guest VM uses for sending and receiving network traffic.

As illustrated in FIG. 1, the two CSP SDN VMs 112, 114 are functionally twins, with the same configuration information, other than the differences in the underlying software stack. In at least one embodiment, only the first instance—the currently active control VM 112—would be present upon boot, with the newly added control standby VM 114 only being generated at upgrade time (represented by the shading as this VM is not initially present), except where redundant VMs may be used. In some embodiments the newly added control standby VM 114 will be created with the new version of the software stack, while in other embodiments the control standby VM 114 will be a copy of the currently active control VM 112, and then the software update will be applied to the control standby VM 114 before the control standby VM 114 is ready to take control of the network traffic. Once the control standby VM 114 takes control, the previously active control VM 112 can be deleted or used for other purposes.

One component, or set of components, in such a system that allows for VM duplication, upgrading, and switchover is an interface layer between the software (e.g., the software stack 124) and the underlying device, such as the NIC 108 (e.g., a CX-7 or CX-8 NIC from NVIDIA Corporation) or a GPU, etc. In this example, there are two access physical functions, PF1 118 and PF2 120 (or “operator” functions), which each correspond to a respective CSP SDN VM 112, 114. In this example, these physical functions are PCI functions. The 108 NIC in this example functions in part as a PCI adaptor, which can expose physical functions such as PF0 122, PF1 118, and PF2 120. The PCI adaptor also exposes a tenant virtual function 110 hosted on a physical port. The two additional access physical functions 118, 120 can correspond to operator functions that can perform duties similar to that of the primary physical function 122. An operator function can be a scalable function, a subfunction, or a scalable input/output virtualization (SIOV) function, among other such options. The primary physical function can support single root I/O virtualization (SR-IOV) in at least one embodiment, allowing a physical PCIe device to present itself one or more times through a PCIe bus, allowing for multiple virtual instances of a device with separate resources. In at least one embodiment, the second access physical function 120 may be created (or provisioned) before the time for an upgrade, but may sit idle until needed. When the newly added VM 114 is launched, the previously idle access physical function 120 can be activated and exposed to the newly added VM 114, such that the access physical function 120 can be operated to manage tenant traffic. The NIC 108 can thus host both access physical functions 118, 120, and allow either physical function to have control access to manage traffic for the tenant virtual function 110 when needed based on which CSP SDN VM 112, 114 is acting as the control VM. The primary physical function 122 can indicate to the first access physical function 118 that it is responsible for controlling traffic, or responsible for the initial control plane, for the tenant virtual function 110 initially.

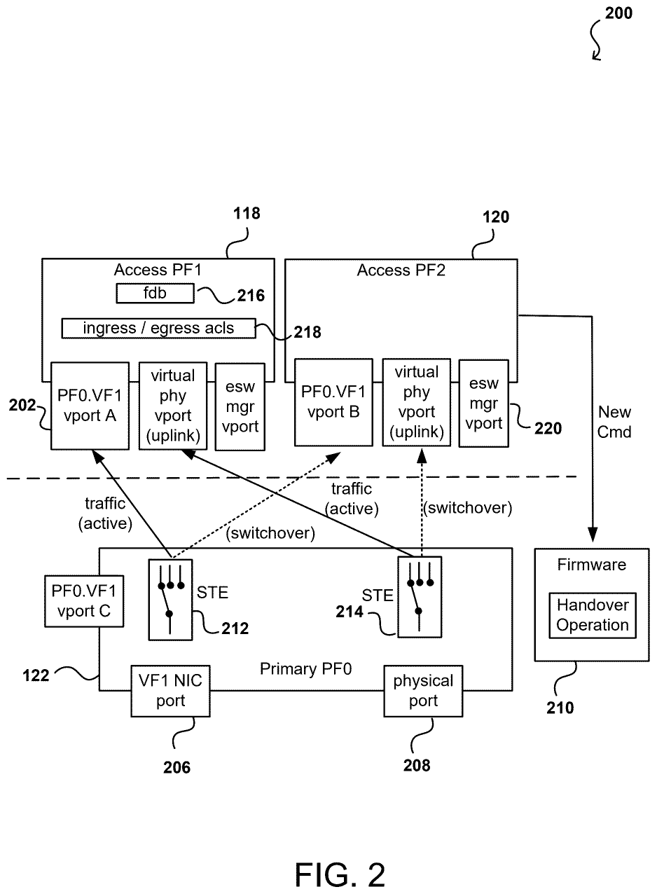

FIG. 2 illustrates an example configuration 200 of a subset of components illustrated in the example system 100 of FIG. 1. Reference numbers may be carried over between figures for similar components for ease of explanation and understanding, but it should be understood that such usage should not be interpreted as a limitation on the scope of the various embodiments unless otherwise specifically stated. In this example, the first access physical function 118 is illustrated as the control function, with the second access physical function 120 being idle or operating in standby mode. The primary physical function 122 is also illustrated, which can direct traffic and provide instructions to the two access physical functions 118, 120.

FIG. 2 illustrates that the primary physical function 122 can include a pair of steering table entries (STEs) 212, 214. These STEs can function as a set of access peers that are both capable of directing active traffic for a tenant VM. These STEs can forward the traffic of the tenant VM and assign the VF vport to one of the switch ports. These switch vports can be either of the access PF (APF) switch vports. This steering essentially determines which control plane is the active entity whose software configuration is to be applied. The active physical function PF1 118 can include a forwarding database 216 and one or more access control lists (ACLs) 218 for routing traffic. The ports 206, 208 here are standard ports in this example that can be used to send and receive traffic. In this example, the primary physical function 122 acts as a switch, where it is connected to a virtual port VF1 206. When the VF NIC port 206 sends and receives traffic, the traffic can virtually enter into the access peer switch as a control plane. In one example, the primary physical function PF0 122 can indicate to physical function PF1 118 that it is sending TCP-IP traffic, which can be received with properties such as a certain MAC address, certain IP address, and certain TCP port, for example, and the traffic can be encrypted and send out over the physical port 208 as part of a typical control plane operation. This can be performed in a twin switch manner in at least one embodiment, with both PF1 118 and PF2 120 doing similar work, using a rule or forwarding database 216 being used by access PF1 for performing tasks such as encapsulation or encryption, or ensuring appropriate quality of service (QoS). The primary physical function 122 thus can operate as a virtual layer 1 switch, where traffic can come from one side and be directed to the appropriate access physical function 118, 120, such as the access physical function that is currently active and responsible for controlling traffic. The primary physical function 122 can thus function as a type of control knob which can direct traffic to the active physical function using a relevant set of interfaces. In at least one embodiment, orchestration software can be used to upgrade the software stack for a new VM, provide the access rules for the corresponding physical function, and issue a command to perform switchover when the newly added VM, upgraded software stack, and corresponding physical function are ready to take control. After switchover, as illustrated, traffic can be directed to access PF2 120, which is associated with the now active control VM. Access physical function PF1 118 (and the associated data path) can then be disconnected. Each access PF 118, 120 can also include an embedded switch manager virtual port (vport) in this east-west architecture. These east switch manager vports 220 can receive packets, which the software should process on the corresponding access physical function. A manager port might analyze packets to be transmitted using one or more rules, such as may indicate which websites are allowed to be accessed. If there is no rule in the hardware allowing access to a website, the packets can be directed to the east switch manager vport 220 to perform a lookup. If the website is listed in a valid database, for example, then a hardware rule can be established, and access to the website can be allowed. This rule can be applied to any traffic received to, or to be transmitted by, the shared hardware, regardless of the active control VM.

As illustrated, each of these access physical functions 118, 120 also has one or more virtual ports that represent the tenant side functions. The vports can control traffic of the first virtual function VF1, and can also include one or more local vports. If a vport is local, that vport does not need to migrate its software stack between physical function. An access physical function switch can determine that it has a first number of local vports and a second number of externally-accessible vports, which can all talk with each other, but during a migration only the second number of externally-accessible vports need to be migrated to the new physical function.

Returning to FIG. 1, there are virtual machines 104, 112, 114 hosted on physical resources of the shared resource environment 102. These VMs have respective network interfaces that allow access to the respective functionality. In at least one embodiment, these VMs can be accessed through in-band or out-of-band communications. For out-of-band communications, there may be another network interface that can be used to access those VMs. In one example, if it can be determined that an access link in access PF2 120 is broken, as access PF1 118 is currently driving the traffic. In some embodiments, in-band access to a VM may be permitted even if that VM is not associated with an active software stack. Referring to FIG. 2, access PF1 118 may have an additional vport that is used for access PF2 120. Access PF1 can set up some smart rules regarding PF2, such as by adding a rule indicating that if a packet belongs to access PF2 120 (based on MAC address or otherwise), and the packet is received to PF1, the packet will be rerouted to PF2 120 using this additional vport. Another possible rule would be to transmit any packet from access PF2 120 onto the physical port 208, allowing for in-band communication. There can also be functionality in the firmware 210 that can be performed during a handover or other such operation. This can include use of an interface to control the STE instances 212, 214 to switch from directing traffic to access PF1 118 (via vport A 220) to directing traffic to access PF2 120 (via vport B). This can be an interface between the relevant drivers of the software stacks and the underlying hardware. In another embodiment, it may be desirable for the software to have more granular control over directing traffic, as may be implemented at the port level. For example, the software may want to adjust the STE switches 212, 214 one at a time. Maybe a physical port 208 will have traffic directed first, followed by traffic for a virtual function NIC port 206, among other such options. Additionally, the software may control individual transmit and receive directions for each of the switching ports.

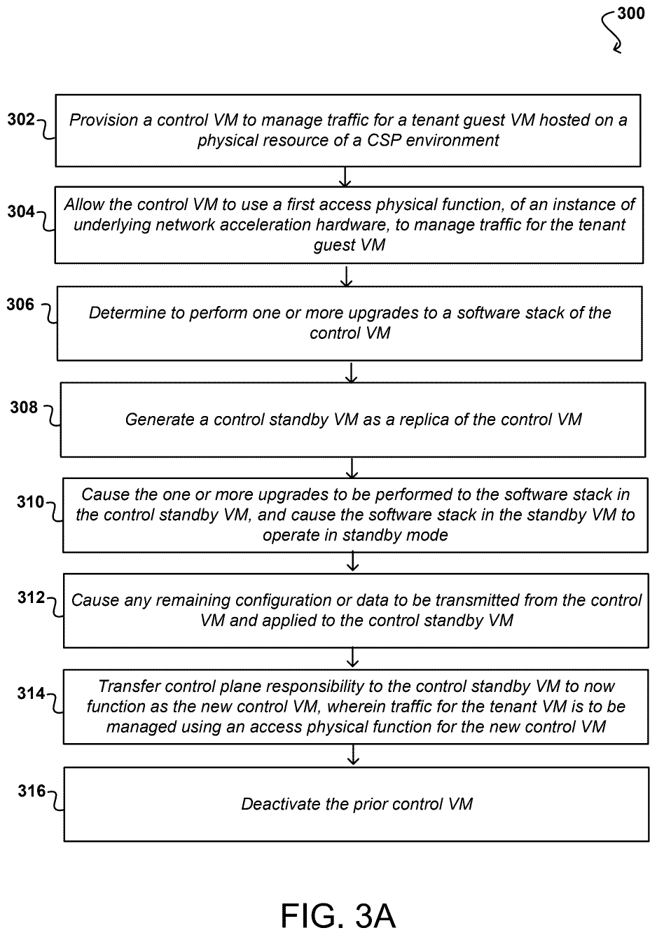

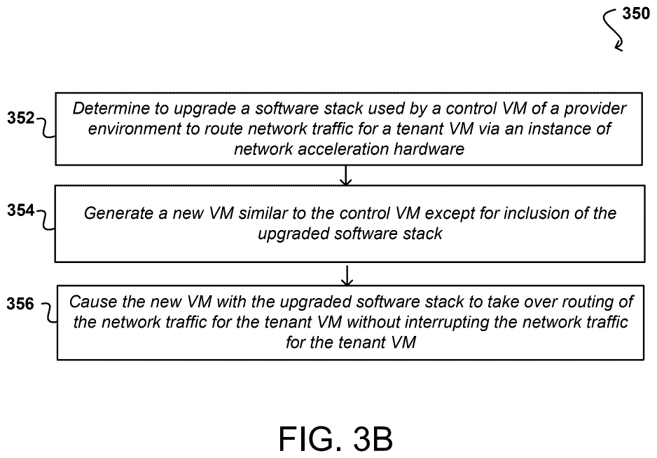

FIG. 3A illustrates an example process 300 that can be performed to update the software stack used to route traffic for a tenant VM in a CSP environment, according to at least one embodiment. It should be understood that for this and other processes presented herein that there may be additional, fewer, or alternative steps performed or similar or alternative orders, or at least partially in parallel, within the scope of the various embodiments unless otherwise specifically stated. Further, although this example is described with respect to tenants and CSPs, various other types of hardware and software deployments can benefit from aspects of such approaches to upgrading or modifying software as well within the scope of the various embodiments. In this example, a control virtual machine (VM) is provisioned 302 to manage traffic for a tenant guest VM hosted on a physical resource of a cloud solution provider (CSP) environment. The control VM can be allowed 304 to use a first access physical function, of an interface layer of an instance of underlying and shared acceleration hardware, to manage traffic for the tenant guest VM. The control VM can manage the active control plane and data plane for the guest VM. At some point, it will be determined 306 to perform one or more upgrades to a software stack of the control VM. As mentioned, the control stack may include a hardware driver, at least one CSP application, and middleware, among other such options in various layers. As part of the upgrade process, a control standby VM can be generated 308 or provisioned that is a replica of the control VM, including the same applications, software stack, and configuration information. The one or more upgrades can be caused 310 to be performed to the software stack in the control standby VM, with the upgraded software stack caused to operate in standby mode. After the upgrading of the software stack in the control standby VM, any remaining data or configuration can be caused 312 to be transmitted from the control VM to be applied to the control standby VM. Once the control standby VM is ready to take control, control plane responsibility can be transferred 314 to the control standby VM, which can now function as a new control VM for managing tenant guest VM traffic. The traffic can be managed using an access physical function for the new control VM with respect to the underlying, shared network acceleration hardware. Once the new control VM is active and able to manage the tenant VM traffic, the prior control VM can be deactivated 316.

FIG. 3B illustrates another example process 350 that can be performed to upgrade a software stack, according to at least one embodiment. In this process, it can be determined 352 to upgrade a software stack that is being used by a control VM of a provider environment (or similar multi-tenant or shared resource environment) to route network traffic for a tenant VM via an instance of network acceleration hardware. A new VM can be generated 354 that is similar to the control VM, such as by being of the same type, having the configuration and size, and other such aspects, except for the inclusion of the upgraded (or other selected) software stack rather than the current software stack of the control VM. When a switchover is then to occur, the new VM with the upgraded software stack can be caused 356 to take over routing of the network traffic for the tenant VM without interrupting the network traffic for the tenant VM. As mentioned, such an approach can allow the software stack to be modified with minimal impact on the relevant network traffic.

As discussed above, a software stack to be upgraded can include multiple layers. In at least one embodiment, this can include a topmost application layer, and under that is at least one middleware (or library) layer that can help to perform the packet switching. Below that can be a kernel stack, such as a bottommost Linux Kernal layer. Use of a standby VM, as discussed herein, allows for upgrading of any or all of these three layers through, for example, a standby upgrade and handover process. In some embodiments, a system may run a software container instead of a VM. In that case, the container may not care about (or work to upgrade) the kernel layer, but can still upgrade the application layer and the middleware layer by launching a second, standby container instead of a second, standby VM. It might be possible, however, that a given implementation is not using a VM or container, but has a new application binary that consists of an image for an application. In this example, a second, standby instance of the application can be installed and/or updated, and a handover can be performed when the application is ready. Using such an approach, a standby and handover process can vary in scope depending on which layer(s) of the software stack are to be upgraded, and whether such process should involve a VM or container, among other such options.

### VIRTUALIZATION HARDWARE

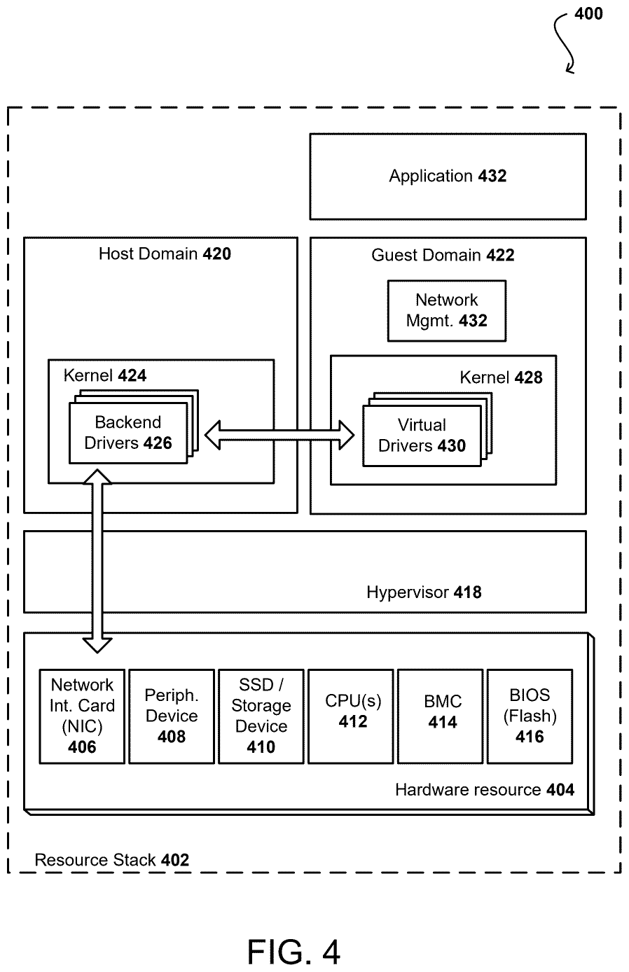

FIG. 4 illustrates an example resource stack 402 of a physical resource 400 that can be provisioned for use with one or more tenants of a datacenter or cloud solution provider environment, according to at least one embodiment. Such a resource can be used as a network router, for example, which can be selected as a waypoint for determining network traffic transmission paths among other such options. When performing tasks, such as network routing tasks using a routing application 432 or service, for example, such resources can include components such as CPUs 412 for executing code to perform these tasks, NICs 406 for communicating network traffic, and memory for storing instructions and networking data. In some embodiments, an entire machine can be allocated for these tasks, or only a portion of the machine, such as to allocate a portion of the resources as a virtual machine in a guest domain 422 that can perform at least some of these tasks.

Such a resource stack 402 can be used to provide an allocated environment for a user (or user of a resource provider) having an operating system provisioned on the resource. In accordance with the illustrated embodiment, the resource stack 402 includes a number of hardware resources 404, such as one or more central processing units (CPUs) 412; solid state drives (SSDs) or other storage devices 410; a network interface card (NIC) 406, one or more peripheral devices (e.g., a graphics processing unit (GPU), etc.) 408, a BIOS implemented in flash memory 416, and a baseboard management controller (BMC) 414, and the like. In some embodiments, the hardware resources 404 reside on a single computing device (e.g., chassis). In other embodiments, the hardware resources can reside on multiple devices, racks, chassis, and the like. Running on top of the hardware resources 404, a virtual resource stack can include a virtualization layer such as a hypervisor 418 for a Xen-based implementation, a host domain 420, and potentially also one or more guest domains 422 capable of executing at least one application 432. The hypervisor 418, if utilized for a virtualized environment, can manage execution of the one or more guest operating systems and allow multiple instances of different operating systems to share the underlying hardware resources 404. Conventionally, hypervisors are installed on server hardware, with the function of running guest operating systems, where the guest operating systems themselves act as servers.

In accordance with an embodiment, a hypervisor 418 can host a number of domains (e.g., virtual machines), such as the host domain 420 and one or more guest domains 422. In one embodiment, the host domain 420 (e.g., the Dom-0) is the first domain created and helps virtualize hardware resources and manage all of the other domains running on the hypervisor 418. For example, the host domain 420 can manage the creating, destroying, migrating, saving, or restoring the one or more guest domains 422 (e.g., the Dom-U). In accordance with various embodiments, the hypervisor 418 can control access to the hardware resources such as the CPU, input/output (I/O) memory, and hypervisor memory.

A guest domain 422 can include one or more virtualized or para-virtualized drivers 430 and the host domain can include one or more backend drivers 426. When the operating system (OS) kernel 428 in the guest domain 422 wants to invoke an I/O operation, the virtualized driver 430 can perform the operation by way of communicating with the backend driver 426 in the host domain 420. When the virtualized driver 430 wants to initiate an I/O operation (e.g., to send out a network packet), a guest kernel component can identify which physical memory buffer contains the packet (or other data) and the virtualized driver 430 can either copy the memory buffer to a temporary storage location in the kernel for performing I/O or obtain a set of pointers to the memory pages that contain the packet(s). In at least one embodiment, these locations or pointers are provided to the backend driver 426 of the host kernel 424 which can obtain access to the data and communicate it directly to the hardware device, such as the NIC 406 for sending the packet over the network.

It should be noted that the resource stack 402 illustrated in FIG. 4 is only one possible example of a set of resources that is capable of providing a virtualized computing environment and that the various embodiments described herein are not necessarily limited to this particular resource stack. In some embodiments, the guest domain 422 can have substantially native or “bare metal” access to the NIC 406 hardware, for example, as provided by device assignment technology based on an IO Memory Management Unit (IO-MMU) device mapping solution like Intel VT-D. In such an implementation, there can be no virtualization layer (e.g., Hypervisor) present. The host domain, or OS, can then be provided by the user, with no guest domains utilized. Other technologies, such Single Root IO Virtualization (SR-IOV), can provide similar “bare metal” functionality to guest domains for only certain functionality of the devices. In general, in various other embodiments, the resource stack can comprise different virtualization strategies, hardware devices, operating systems, kernels, domains, drivers, hypervisors and other resources.

In compute servers, a BMC 414 can maintain a list of events that have occurred in the system, referred to herein as a system event log (SEL). In at least one embodiment, the BMC 414 can receive system event logs from the BIOS 416 on the host processor. The BIOS 416 can provide data for system events over an appropriate interface, such as an I²C interface, to the BMC using an appropriate protocol, such as an SMBus System Interface (SSIF) or KCS interface over LPC. As mentioned, an example of a system event log event from BIOS includes an uncorrectable memory error, indicating a bad RAM stick. In at least some embodiments, system event logs recorded by BMCs on various resources can be used for purposes such as to monitor server health, including triggering manual replacement of parts or instance degrade when SELs from the BIOS indicate failure.

As mentioned, in a virtualized environment the hypervisor 418 can prevent the guest operating system, or guest domain 422, from sending such system event log data to the BMC 414. In the case of bare metal access without such a hypervisor, however, user instances can have the ability to send data for system event that spoof events from the BIOS 416. Such activity could lead to compromised bare metal instances being prematurely degraded due to fake system event data produced by the user OS.

In at least one embodiment, however, there will be portions of the physical resource 400 that will be inaccessible to the user OS. This can include, for example, at least a portion of BIOS memory 416. BIOS memory 416 in at least one embodiment is volatile memory such that any data stored to that memory will be lost in the event of a reboot or power down event. The BIOS can keep at least a portion of host memory unmapped, such that it is not discoverable by a host OS. As mentioned, data such as a secret token can be stored to BIOS memory 416 at boot time, before a user OS is executing on the resource. Once the user OS is executing on the resource, that OS will be prevented from accessing that secret token in BIOS memory 416. In at least one embodiment, this secret token (or other stored secret) can be provided to the BMC 414 when adding system event log events, whereby the BMC 414 can confirm that the event is being sent by the BIOS 416 and not by the user OS.

### DATACENTER

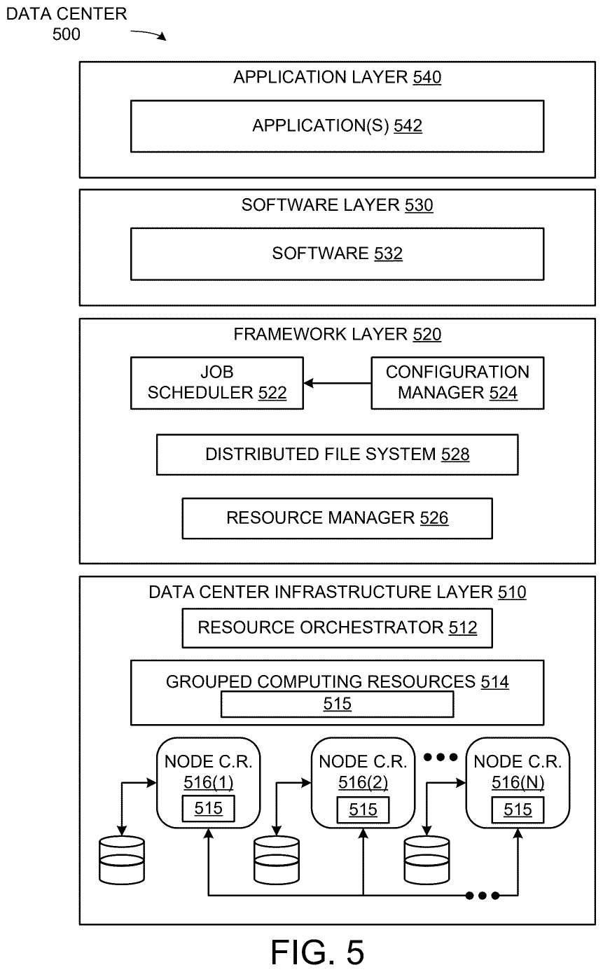

FIG. 5 illustrates the architecture of an example datacenter 500, in which at least one embodiment may be implemented. In at least one embodiment, data in this datacenter 500 includes a datacenter infrastructure layer 510, a framework layer 520, a software layer 530, and an application layer 540.

In at least one embodiment, as shown in FIG. 5, datacenter infrastructure layer 510 may include a resource orchestrator 512, grouped computing resources 514, and node computing resources (“node C.R.s”) 516(1)-516(N), where “N” represents a positive integer (which may be a different integer “N” than used in other figures). In at least one embodiment, node C.R.s 516(1)-516(N) may include, but are not limited to, any number of central processing units (“CPUs”) or other processors (including accelerators, field programmable gate arrays (FPGAs), graphics processors, etc.), memory storage devices 518(1)-518(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 516(1)-516(N) may be a server having one or more of above-mentioned computing resources.

In at least one embodiment, grouped computing resources 514 may include separate groupings of node C.R.s housed within one or more racks (not shown), or many racks housed in datacenters at various geographical locations (also not shown). In at least one embodiment, separate groupings of node C.R.s within grouped computing resources 514 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 512 may configure or otherwise control one or more node C.R.s 516(1)-516(N) and/or grouped computing resources 514. In at least one embodiment, resource orchestrator 512 may include a software design infrastructure (“SDI”) management entity for datacenter 500. In at least one embodiment, resource orchestrator 512 may include hardware, software or some combination thereof.

In at least one embodiment, as shown in FIG. 5, framework layer 520 includes a job scheduler 522, a configuration manager 524, a resource manager 526 and a distributed file system 528. In at least one embodiment, framework layer 520 may include a framework to support software 532 of software layer 530 and/or one or more application(s) 542 of application layer 540. In at least one embodiment, software 532 or application(s) 542 may respectively include web-based service software or applications, such as those provided by Amazon Web Services, Google Cloud and Microsoft Azure. In at least one embodiment, framework layer 520 may be, but is not limited to, a type of free and open-source software web application framework such as Apache Spark™ (hereinafter “Spark”) that may utilize distributed file system 528 for large-scale data processing (e.g., “big data”). In at least one embodiment, job scheduler 522 may include a Spark driver to facilitate scheduling of workloads supported by various layers of datacenter 500. In at least one embodiment, configuration manager 524 may be capable of configuring different layers such as software layer 530 and framework layer 520 including Spark and distributed file system 528 for supporting large-scale data processing. In at least one embodiment, resource manager 526 may be capable of managing clustered or grouped computing resources mapped to or allocated for support of distributed file system 528 and job scheduler 522. In at least one embodiment, clustered or grouped computing resources may include grouped computing resources 514 at datacenter infrastructure layer 510. In at least one embodiment, resource manager 526 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 528 of framework layer 520. In at least one embodiment, one or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 528 of framework layer 520. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 524, resource manager 526, and resource orchestrator 512 may implement any number and type of self-modifying actions based on any amount and type of data acquired in any technically feasible fashion. In at least one embodiment, self-modifying actions may relieve a datacenter operator of datacenter 500 from making possibly bad configuration decisions and possibly avoiding underutilized and/or poor performing portions of a datacenter.

In at least one embodiment, datacenter 500 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 500. In at least one embodiment, trained machine learning models corresponding to one or more neural networks may be used to infer or predict information using resources described above with respect to datacenter 500 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 5 for inferencing or predicting operations based, at least in part, on weight parameters calculated using neural network training operations, neural network functions and/or architectures, or neural network use cases described herein.

Embodiments presented herein allow for the upgrading of a software stack to be used with virtualization hardware without interrupting tenant traffic.

### COMPUTER SYSTEMS

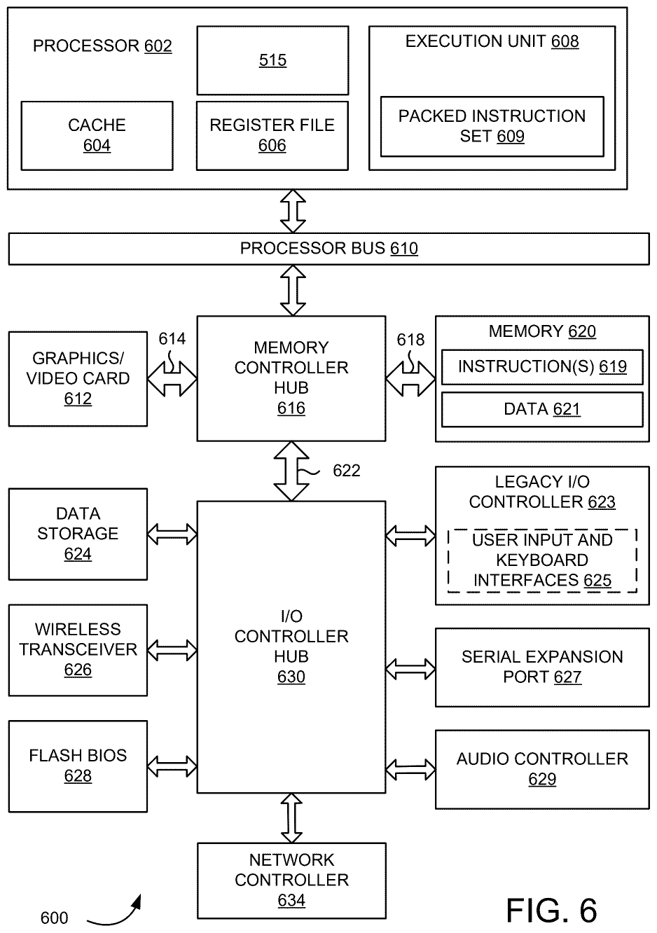

FIG. 6 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 600 may include, without limitation, a component, such as a processor 602 to employ execution units including logic to perform algorithms for process data, in accordance with present disclosure, such as in embodiment described herein. In at least one embodiment, computer system 600 may include processors, such as PENTIUM® Processor family, Xeon™, Itanium®, Scale™ and/or StrongARM™, Intel® Core™, or Intel® Nirvana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“Necks”), set-top boxes, network hubs, wide area network (“WAN”) switches, or any other system that may perform one or more instructions in accordance with at least one embodiment.

In at least one embodiment, computer system 600 may include, without limitation, processor 602 that may include, without limitation, one or more execution units 608 to perform machine learning model training and/or inferencing according to techniques described herein. In at least one embodiment, computer system 600 is a single processor desktop or server system, but in another embodiment, computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. Other embodiments may also include a combination of both internal and external caches depending on particular implementation and needs. In at least one embodiment, a register file 606 may store different types of data in various registers including, without limitation, integer registers, floating point registers, status registers, and an instruction pointer register.

In at least one embodiment, execution unit 608, including, without limitation, logic to perform integer and floating point operations, also resides in processor 602. In at least one embodiment, processor 602 may also include a microcode (“code”) read only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor, along with associated circuitry to execute instructions, operations used by many multimedia applications may be performed using packed data in processor 602. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be a Dynamic Random Access Memory (“DRAM”) device, a Static Random Access Memory (“SRAM”) device, a flash memory device, or another memory device. In at least one embodiment, memory 620 may store instruction(s) 619 and/or data 621 represented by data signals that may be executed by processor 602.

In at least one embodiment, a system logic chip may be coupled to processor bus 610 and memory 620. In at least one embodiment, a system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data, and textures. In at least one embodiment, MCH 616 may direct data signals between processor 602, memory 620, and other components in computer system 600 and to bridge data signals between processor bus 610, memory 620, and a system I/O interface 622. In at least one embodiment, a system logic chip may provide a graphics port for coupling to a graphics controller. In at least one embodiment, MCH 616 may be coupled to memory 620 through high bandwidth memory path 618 and a graphics/video card 612 may be coupled to MCH 616 through an Accelerated Graphics Port (“AGP”) interconnect 614.

In at least one embodiment, computer system 600 may use system I/O interface 622 as a proprietary hub interface bus to couple MCH 616 to an I/O controller hub (“ICH”) 630. In at least one embodiment, ICH 630 may provide direct connections to some I/O devices via a local I/O bus. In at least one embodiment, a local I/O bus may include, without limitation, a high speed I/O bus for connecting peripherals to memory 620, a chipset, and processor 602. Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as a Universal Serial Bus (“USB”) port, and a network controller 634. In at least one embodiment, data storage 624 may comprise a hard disk drive, a floppy disk drive, a CD-ROM device, a flash memory device, or other mass storage device.

In at least one embodiment, FIG. 6 illustrates a system, which includes interconnected hardware devices or “chips”, whereas in other embodiments, FIG. 6 may illustrate an exemplary SoC In at least one embodiment, devices illustrated in FIG. 6 may be interconnected with proprietary interconnects, standardized interconnects (e.g., PCIe) or some combination thereof. In at least one embodiment, one or more components of computer system 600 are interconnected using compute express link (CXL) interconnects.

Inference and/or training logic 515 are used to perform inferencing and/or training operations associated with one or more embodiments. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Embodiments presented herein allow for the upgrading of a software stack to be used with virtualization hardware without interrupting tenant traffic.

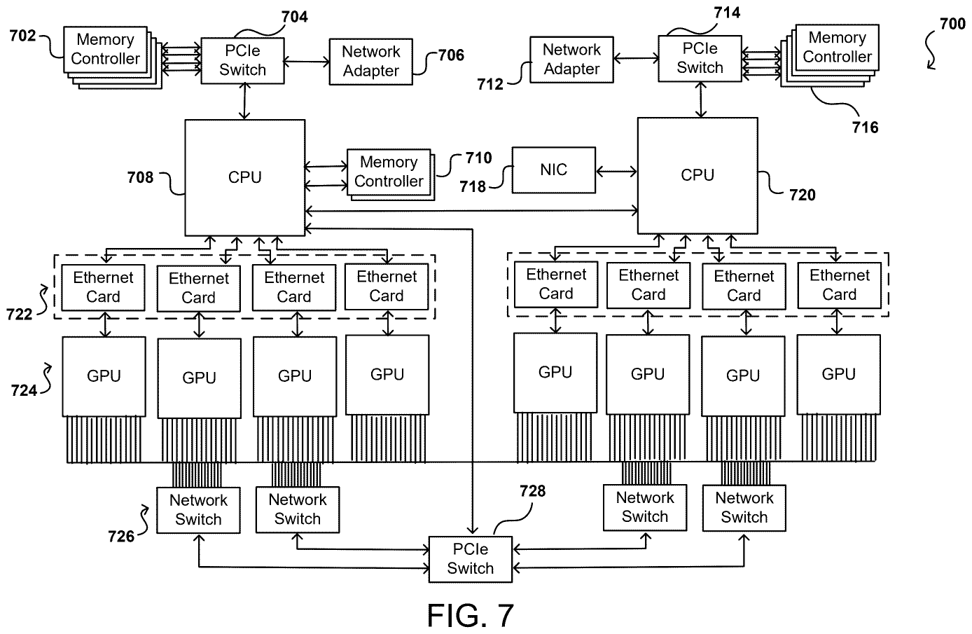

FIG. 7 illustrates an example enterprise AI system that can be used to perform at least AI-related tasks in accordance with at least one embodiment. An example of such a system is an H100 or H200 DGX system implementing the NVIDIA DGX™ platform from NVIDIA Corporation. The NVIDIA DGX™ H100/H200 Systems are built for all AI infrastructure and workloads from analytics to training to inference. The DGX H100/H200 systems are built on eight GPUs 724, such as NVIDIA H100 Tensor Core GPUs or eight NVIDIA H200 Tensor Core GPUs. Although not illustrated in FIG. 7, other types of processing units can be used as well, such as data processing units (DPUs). The illustrated system 700 includes a pair of CPUs 708, 720, such as Intel Xeon CPUs with 56 cores each. The CPUs 708, 720 are connected to the eight GPUs 724 using a set of Ethernet cards 722, such as ConnectX-7 Network Modules, which are connected in turn to a number of network switches 726, such as NVSwitches. The network switches 726 are connected to a PCIe switch 728, which can be connected back to at least one of the CPUs 708. A first CPU 708 can be connected directly to a memory controller 710, such as an NVMe controller, and to other memory controllers 702 indirectly through a PCIe switch 704, which can also connect the CPU 708 to a network adapter 706, such as a ConnectX-7 adapter. A second CPU 720 can be connected to the first CPU 708 as well as a network interface card (NIC) 718. The second CPU 720 can also be connected, through another PCIe switch 714, to a network adapter 712 and one or more memory controllers 716.

An example Nvidia DGX (Deep GPU Xceleration) implementation can include a number of servers and workstations that are geared towards enhancing deep learning applications through the use of general-purpose computing on graphics processing units (GPUs). Such systems may come in a rackmount format featuring high-performance x86 server CPUs on the motherboard. A core feature of an example DGX system is its inclusion of 8 or more NVIDIA GPU modules, which are housed on an independent system board. These GPUs can be connected either via a version of the SXM socket or a PCIe x16 slot, facilitating flexible integration within the system architecture. To manage the substantial thermal output, DGX units are equipped with heatsinks and fans designed to maintain optimal operating temperatures. This framework makes DGX units suitable for computational tasks associated with artificial intelligence and machine learning models. In one embodiment, the GPUs can be connected using an NVLink mesh network.

Embodiments presented herein allow for the upgrading of a software stack to be used with virtualization hardware without interrupting tenant traffic.

Various embodiments can be described by the following clauses:
1. A system, comprising:
   one or more processing units to:
   determine to upgrade a software stack used by a control virtual machine (VM) of a provider environment to route network traffic for a tenant VM via an instance of network acceleration hardware;
   generate a control standby VM similar to the control VM except for inclusion of the upgraded software stack; and
   cause, at a time for switchover, the control standby VM with the upgraded software stack to take control over routing of the network traffic for the tenant VM, using the instance of network acceleration hardware, without significantly interrupting the network traffic for the tenant VM.
2. The system of clause 1, wherein the switchover includes transferring control plane responsibility for the network traffic, to be routed using the instance of networking acceleration hardware, from the control VM to the control standby VM, wherein the control standby VM becomes an active control VM.
3. The system of clause 1, wherein the instance of networking hardware is a network interface card (NIC) or a data processing unit (DPU).
4. The system of clause 1, wherein the network traffic is routed using east-west networking infrastructure.
5. The system of clause 1, further comprising:
   an interface layer allowing access to the instance of networking hardware, the interface layer including a first operator function for the control VM and a second operator function for the control standby VM.
6. The system of clause 5, wherein the interface layer includes a primary physical function to indicate to a first operator function of the interface that the first operator function is initially in charge of a control plane by default.
7. The system of clause 5, wherein the first operation function is a physical function, a virtual function, a scalable function, a subfunction, or a scalable input/output virtualization (SIOV) function.
8. The system of clause 5, wherein both the first operator function and the second operator function include one or more virtual switching ports representing and controlling tenant-side functionality.
9. The system of clause 1, wherein the time for switchover is determined using the software stack.
10. The system of clause 1, wherein the control VM and the control standby VM are each allowed to be accessed using in-band or out-of-band communications.
11. The system clause 1, wherein the instance of network acceleration hardware exposes multiple control plane entities for a network device presented to the tenant VM, as may include at least a switch control plane, one or more switch representor ports, or a forwarding databases.
12. The system of clause 1, wherein the instance of network acceleration hardware allows software to perform handover of a traffic control plane between control VMs without disrupting network packets.
13. The system of clause 1, wherein the instance of network acceleration hardware is allowed to delegate permission to one or more other network acceleration devices to perform control plane management.
14. At least one processor comprising processing circuitry to update software used to route network traffic for a tenant VM using an instance of routing hardware by, in part, generating a new VM similar to a current VM except for inclusion of updated software, the processing circuitry further to cause the new VM to take over, from the current VM, control plane responsibility for the network traffic of the tenant VM to be routed using the instance of routing hardware.
15. The at least one processor of clause 14, wherein the updated software includes at least one of an new version, a prior version, or an alternative version of the software.
16. The at least one processor of clause 14, wherein the network traffic is to be routed using east-west networking infrastructure.
17. The at least one processor of clause 14, wherein a second software update to is update an application and middleware without updating a kernel layer, and wherein the at least one processor is further to generate a new software container with the second software update and cause the new software container to take over from a current software container after the second software update has completed.
18. A software version manager for a datacenter, comprising:
   one or more processing units to:
   determine to upgrade a software stack used by a current virtual machine (VM) of a provider environment to route network traffic for a tenant VM via an instance of network acceleration hardware;
   generate a new VM similar to the current VM except for inclusion of the upgraded software stack; and
   cause, at a time for switchover, the new VM with the upgraded software stack to take control over routing of the network traffic for the tenant VM, using the instance of network acceleration hardware, without interrupting the network traffic for the tenant VM.
19. The software version manager of clause 18, wherein the switchover includes transferring control plane responsibility for the network traffic, to be routed using the instance of networking acceleration hardware, from the current VM to the new VM.
20. The software version manager of clause 18, wherein the one or more processing units is further to allow access, via an interface layer, to the instance of networking hardware, the interface layer including a first operator function for the current VM and a second operator function for the new VM.
21. At least one processor comprising processing circuitry to update software used to route network traffic for a tenant VM using an instance of routing hardware by, in part, generating a new controller similar to a current controller except for inclusion of updated software, the processing circuitry further to cause the new controller to take over, from the current controller, control plane responsibility for the network traffic of the tenant controller to be routed using the instance of routing hardware, wherein the current controller and the new controller comprise control plane containers or Kubernetes Pods.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processing units to:
determine to upgrade a software stack used by a control virtual machine (VM) of a provider environment to route network traffic for a tenant VM via an instance of network acceleration hardware;
generate a control standby VM similar to the control VM except for inclusion of the upgraded software stack; and
cause, at a time for switchover, the control standby VM with the upgraded software stack to take control over routing of the network traffic for the tenant VM, using the instance of network acceleration hardware, without significantly interrupting the network traffic for the tenant VM.

2. The system of claim 1, wherein the switchover includes transferring control plane responsibility for the network traffic, to be routed using the instance of networking acceleration hardware, from the control VM to the control standby VM, wherein the control standby VM becomes an active control VM.

3. The system of claim 1, wherein the instance of networking hardware is a network interface card (NIC) or a data processing unit (DPU).

4. The system of claim 1, wherein the network traffic is routed using east-west networking infrastructure.

5. The system of claim 1, further comprising:
an interface layer allowing access to the instance of networking hardware, the interface layer including a first operator function for the control VM and a second operator function for the control standby VM.

6. The system of claim 5, wherein the interface layer includes a primary physical function to indicate to a first operator function of the interface that the first operator function is initially in charge of a control plane by default.

7. The system of claim 5, wherein the first operation function is a physical function, a virtual function, a scalable function, a subfunction, or a scalable input/output virtualization (SIOV) function.

8. The system of claim 5, wherein both the first operator function and the second operator function include one or more virtual switching ports representing and controlling tenant-side functionality.

9. The system of claim 1, wherein the time for switchover is determined using the software stack.

10. The system of claim 1, wherein the control VM and the control standby VM are each allowed to be accessed using in-band or out-of-band communications.

11. The system claim 1, wherein the instance of network acceleration hardware exposes multiple control plane entities for a network device presented to the tenant VM, as may include at least a switch control plane, one or more switch representor ports, or a forwarding databases.

12. The system of claim 1, wherein the instance of network acceleration hardware allows software to perform handover of a traffic control plane between control VMs without disrupting network packets.

13. The system of claim 1, wherein the instance of network acceleration hardware is allowed to delegate permission to one or more other network acceleration devices to perform control plane management.

14. At least one processor comprising processing circuitry to update software used to route network traffic for a tenant VM using an instance of routing hardware by, in part, generating a new VM similar to a current VM except for inclusion of updated software, the processing circuitry further to cause the new VM to take over, from the current VM, control plane responsibility for the network traffic of the tenant VM to be routed using the instance of routing hardware.

15. The at least one processor of claim 14, wherein the updated software includes at least one of an new version, a prior version, or an alternative version of the software.

16. The at least one processor of claim 14, wherein the network traffic is to be routed using east-west networking infrastructure.

17. The at least one processor of claim 14, wherein a second software update to is update an application and middleware without updating a kernel layer, and wherein the at least one processor is further to generate a new software container with the second software update and cause the new software container to take over from a current software container after the second software update has completed.

18. A software version manager for a datacenter, comprising:
one or more processing units to:
determine to upgrade a software stack used by a current virtual machine (VM) of a provider environment to route network traffic for a tenant VM via an instance of network acceleration hardware;
generate a new VM similar to the current VM except for inclusion of the upgraded software stack; and
cause, at a time for switchover, the new VM with the upgraded software stack to take control over routing of the network traffic for the tenant VM, using the instance of network acceleration hardware, without interrupting the network traffic for the tenant VM.

19. The software version manager of claim 18, wherein the switchover includes transferring control plane responsibility for the network traffic, to be routed using the instance of networking acceleration hardware, from the current VM to the new VM.

20. The software version manager of claim 18, wherein the one or more processing units is further to allow access, via an interface layer, to the instance of networking hardware, the interface layer including a first operator function for the current VM and a second operator function for the new VM.

21. At least one processor comprising processing circuitry to update software used to route network traffic for a tenant VM using an instance of routing hardware by, in part, generating a new controller similar to a current controller except for inclusion of updated software, the processing circuitry further to cause the new controller to take over, from the current controller, control plane responsibility for the network traffic of the tenant controller to be routed using the instance of routing hardware, wherein the current controller and the new controller comprise control plane containers or Kubernetes Pods.
